(19) United States
(12) Patent Application Publication
(10) Pub. No.: US 2024/0249673 A1
(43) Pub. Date: Jul. 25, 2024

(54) DISPLAY DEVICE

(71) Applicant: Japan Display Inc., Tokyo (JP)

(72) Inventor: Akihiro OGAWA, Tokyo (JP)

(73) Assignee: Japan Display Inc., Tokyo (JP)

(21) Appl. No.: 18/628,096

(22) Filed: Apr. 5, 2024

Related U.S. Application Data
(63) Continuation of application No. PCT/JP2022/036698, filed on Sep. 30, 2022.

(30) Foreign Application Priority Data
Oct. 6, 2021 (JP) 2021-164747

(51) Int. Cl. G09G 3/32

(52) U.S. Cl. CPC G09G 3/32; G09G 2300/0452; G09G 2320/0626

(57) ABSTRACT

A display device includes a display area where an image is displayed, and a plurality of pixels arrayed in a matrix in the display area. Each of the plurality of pixels includes a first light source, a second light source, and a first drive circuit controlling operations of the first light source and the second light source. The first drive circuit turns off the second light source when turning on the first light source, and turns off the first light source when turning on the second light source.

### CROSS-REFERENCE TO RELATED APPLICATIONS

This application is a Continuation Application of PCT Application No. PCT/JP2022/036698, filed Sep. 30, 2022 and based upon and claiming the benefit of priority from Japanese Patent Application No. 2021-164747, filed Oct. 6, 2021, the entire contents of all of which are incorporated herein by reference.

### FIELD

Embodiments described herein relate generally to a display device.

### BACKGROUND

Generally, an LED display using the light emitting diode (LED) which is a self-luminous element is known but, recently, a display device (hereinafter referred to as a micro-LED display) using a minute diode element referred to as a micro-LED has been developed.

Since a number of chip-shaped micro-LEDs are mounted in a display area, unlike a conventional liquid crystal display or organic EL display, the micro-LED display can easily achieve both high definition and upsizing and is focused as a next generation display.

In contrast, since the micro-LED has a characteristic that the luminance efficiency (which may be simply referred to as luminance) decreases as the temperature rises, there is a problem that the display quality of the micro-LED display using the micro-LED becomes lower as the lighting time of the LED is longer.

### BRIEF DESCRIPTION OF THE DRAWINGS

FIG. 1 is a perspective view showing a configuration example of a display device according to an embodiment.

FIG. 2 is a plan view showing a configuration example of a display area according to the embodiment.

FIG. 3 is an equivalent circuit diagram showing a configuration example of a sub-pixel according to the embodiment.

FIG. 4 is an equivalent circuit diagram showing another configuration example of a sub-pixel according to the embodiment.

FIG. 5 is a view illustrating a lighting operation of a light source according to the embodiment.

FIG. 6 is a graph illustrating temperature characteristics of a micro-LED.

FIG. 7 is a plan view showing another configuration example of the display area according to the embodiment.

### DETAILED DESCRIPTION

In general, according to one embodiment, a display device comprises a display area where an image is displayed; and a plurality of pixels arrayed in a matrix in the display area. Each of the plurality of pixels comprises a first light source, a second light source, and a first drive circuit controlling operations of the first light source and the second light source. The first drive circuit turns off the second light source when turning on the first light source, and turns off the first light source when turning on the second light source.

An embodiment will be described hereinafter with reference to the accompanying drawings.

The disclosure is merely an example, and proper changes within the spirit of the invention, which are easily conceivable by a person of ordinary skill in the art, are included in the scope of the invention as a matter of course. In addition, in some cases, in order to make the description clearer, the invention may be schematically illustrated in the drawings, as compared to the aspects of the embodiments. However, the schematic illustration is merely an example, and adds no restriction to the interpretation of the invention. In addition, in the specification and drawings, structural elements which function in the same or a similar manner to those described in connection with preceding drawings are denoted by like reference numbers, detailed description thereof being omitted unless necessary.

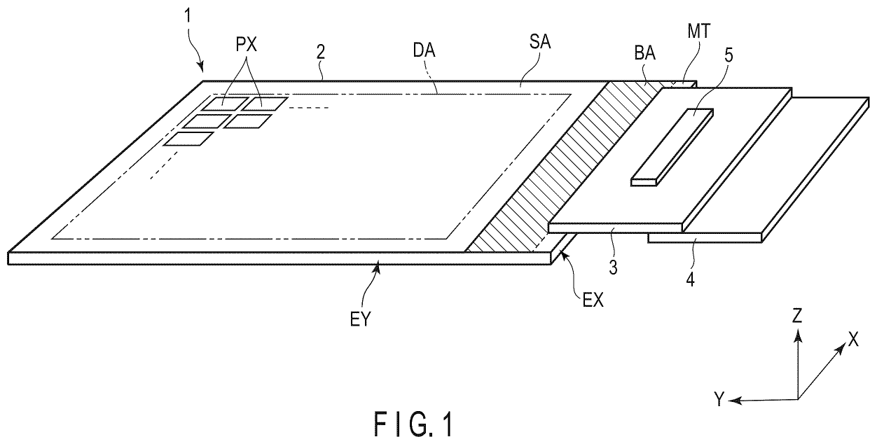

FIG. 1 is a perspective view schematically showing a configuration of a display device 1 according to an embodiment. FIG. 1 shows a three-dimensional space defined by a first direction X, a second direction Y perpendicular to the first direction X, and a third direction Z perpendicular to the first direction X and the second direction Y. Incidentally, the first direction X and the second direction Y are orthogonal to each other, but may intersect at an angle other than 90 degrees. In the present specification, viewing the display device 1 from a direction parallel to the third direction Z is referred to as plan view.

An example in which the display device 1 is a micro-LED display using the micro-LED which is a self-luminous element as a light source in the embodiment will be described below.

As shown in FIG. 1, the display device 1 comprises a display panel 2, a first circuit board 3, a second circuit board 4, and the like.

The display panel 2 has, for example, a rectangular shape. In the example illustrated, short sides EX of the display panel 2 are parallel to the first direction X, and long sides EY of the display panel 2 are parallel to the second direction Y. The third direction Z corresponds to a thickness direction of the display panel 2. The first direction X may be restated as a direction parallel to the short sides of the display device 1, the second direction Y may be restated as a direction parallel to the long sides of the display device 1, and the third direction Z may be restated as a thickness direction of the display device 1. A main surface of the display panel 2 is parallel to an X-Y plane defined by the first direction X and the second direction Y. The display panel 2 has a display area DA (display part) and a non-display area NDA located outside the display area DA. A surrounding area SA has a terminal area MT. In the example illustrated, the surrounding area SA surrounds the display area DA.

The display area DA is an area for displaying images and includes, for example, a plurality of pixels PX arrayed in a matrix. The pixel PX includes a light source (micro-LED), a switching element (drive transistor) for driving the light source, and the like.

The terminal area MT is provided along the short sides EX of the display panel 2 and includes terminals for electrically connecting the display panel 2 to external devices and the like.

The first circuit board 3 is mounted on the terminal area MT and is electrically connected to the display panel 2. The first circuit board 3 is, for example, a flexible printed circuit board. The first circuit board 3 comprises a driver IC chip (hereinafter referred to as a panel driver) 5 which drives the display panel 2, and the like. Incidentally, in the example illustrated, the panel driver 5 is arranged on the first circuit board 3, but may be arranged under the first circuit board 3. Alternatively, the panel driver 5 maybe mounted on a part other than the first circuit board 3. In this case, the panel driver 5 may be mounted on the surrounding area SA of the display panel 2 or may be mounted on the second circuit board 4. The second circuit board 4 is, for example, a rigid printed circuit board. For example, the second circuit board 4 is connected to the first circuit board 3 at a position under the first circuit board 3.

For example, the panel driver 5 is connected to a control board (not shown) via the second circuit board 4. For example, the panel driver 5 performs control of displaying images on the display panel 2 by driving a plurality of pixels PX, based on image signals output from the control board.

Incidentally, the display panel 2 may include a fold area BA represented by hatch lines. The fold area BA is an area which is bent when the display device 1 is accommodated in a housing of an electronic apparatus or the like. The fold area BA is located on the terminal area MT side of the surrounding area SA. In a state in which the fold area BA is bent, the first circuit board 3 and the second circuit board 4 are arranged to be opposed to the display panel 2.

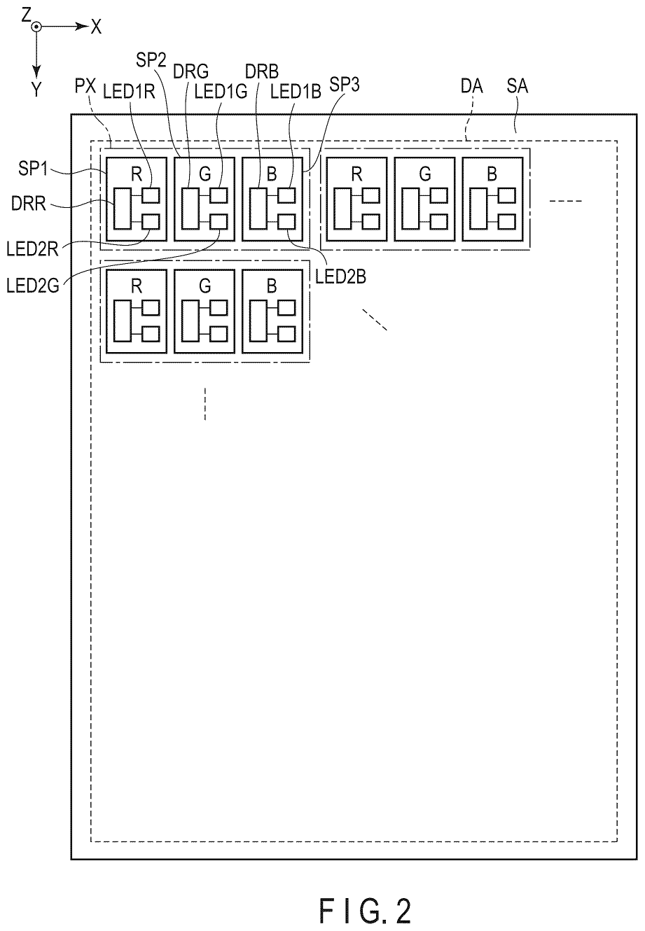

FIG. 2 is a plan view schematically showing the display area DA according to the present embodiment. As shown in FIG. 2, a plurality of pixels PX are arrayed in a matrix in the first direction X and the second direction Y, in the display area DA. The pixel PX comprises a sub-pixel SP1 that emits red (R) light, a sub-pixel SP2 that emits green (G) light, and a sub-pixel SP3 that emits blue (B) light. Incidentally, the pixel PX may comprise sub-pixels emitting light other than red, green and blue. In the present specification, the sub-pixels SP1 to SP3 may be simply referred to as sub-pixels SP when the sub-pixels do not need to be distinguished.

The sub-pixels SP1 to SP3 each comprise a plurality of light sources LED1 and LED2 and a drive circuit DR for driving these light sources LED1 and LED2. More specifically, the sub-pixel SP1 is a light source that emits red light, and comprises two light sources LED1R and LED2R with the same performance, and a drive circuit DRR for driving these light sources LED1R and LED2R. Similarly, the sub-pixel SP2 is a light source that emits green light, and comprises two light sources LED1G and LED2G with the same performance, and a drive circuit DRG for driving these light sources LED1G and LED2G. In addition, the sub-pixel SP3 is a light source that emits blue light, and comprises two light sources LED1B and LED2B with the same performance, and a drive circuit DRB for driving these light sources LED1B and LED2B. In the present specification, the light source LED1R, the light source LED1G, and the light source LED1B may be simply referred to as light sources LED1 when the light sources do not need to be distinguished. Similarly, the light source LED2R, the light source LED2G, and the light source LED2B may be simply referred to as light sources LED2 when the light sources do not need to be distinguished. In addition, the drive circuit DRR, the drive circuit DRG, and the drive circuit DRB may be simply referred to as drive circuits DR when the drive circuits do not need to be distinguished.

Although the details will be described later, the two light sources LED1 and LED2 included in the sub-pixel SP are turned on at different timing by the drive circuit DR. In other words, the light source LED2 is turned off when the light source LED1 included in the sub-pixel SP is turned on, and the light source LED1 is turned off when the light source LED2 is turned on.

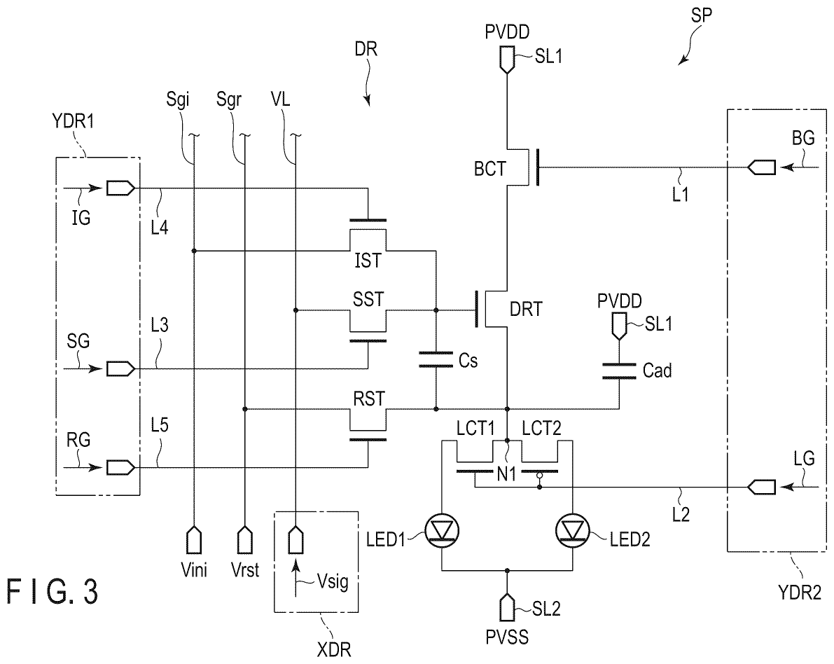

FIG. 3 is an equivalent circuit diagram of the sub-pixel SP included in the pixel PX. The sub-pixel SP includes two light sources LED1 and LED2 connected in parallel and a drive circuit DR that supplies drive currents to these light sources LED1 and LED2.

The drive circuit DR of the sub-pixel SP is a voltage signal type drive circuit that controls turning on/off of the light sources LED1 and LED2 in accordance with video signal Vsig composed of a voltage signal, and includes a reset switch RST, a pixel selection switch SST, an initializing switch IST, an output switch BCT, a drive transistor DRT, lighting control switches LCT1 and LCT2, a storage capacitor Cs, and an auxiliary capacitor Cad. The storage capacitor Cs and the auxiliary capacitor Cad are capacitors. The auxiliary capacitor Cad is an element provided to adjust the amount of a drive current and may be unnecessary in some cases.

The reset switch RST, the pixel selection switch SST, the initializing switch IST, the output switch BCT, and the drive transistor DRT are composed of thin-film transistors (TFT). In the present embodiment, the reset switch RST, the pixel selection switch SST, the initializing switch IST, the output switch BCT, the drive transistor DRT, and the lighting control switch LCT1 are composed of, for example, N-channel TFT. In contrast, the lighting control switch LCT2 is composed of, for example, a P-channel TFT. Incidentally, the reset switch RST, the pixel selection switch SST, the initializing switch IST, the output switch BCT, and the lighting control switches LCT1 and LCT2 need only to function as switches, and do not need to be composed of TFT.

The reset switch RST, the pixel selection switch SST, the initializing switch IST, the output switch BCT, the drive transistor DRT, and the lighting control switches LCT1 and LCT2 each include a source electrode, a drain electrode, and a gate electrode.

In the drive circuit DR of the sub-pixel SP, the drive transistor DRT and the output switch BCT are connected in series with the light source LED1 between the first power line SL1 and the second power line SL2. In addition, in the drive circuit DR of the sub-pixel SP, the drive transistor DRT and the output switch BCT are also connected in series with the light source LED2 between the first power line SL1 and the second power line SL2. The first power line SL1 is a high potential power line fixed to high potential PVDD, and the second power line SL2 is a low potential power line fixed to low potential PVSS. Ideally, the light sources LED1 and LED2 are supplied with a drive current by the potential difference between the high potential PVDD and the low potential PVSS and are turned on. In other words, the high potential PVDD has a potential difference with respect to the low potential PVSS, which is sufficient to turn on the light sources LED1 and LED2. More specifically, the high potential PVDD is set to a potential of, for example, 10V, and the low potential PVSS is set to a potential of, for example, 1.5V.

In the output switch BCT, the drain electrode is connected to the first power line SL1, the source electrode is connected to the drain electrode of the drive transistor DRT, and the gate electrode is connected to an output control signal line L1. The output switch BCT is controlled to be turned on (conductive state) or off (non-conductive state) by a control signal BG supplied to the output control signal line L1. The output switch BCT controls the lighting time of the light sources LED1 and LED2 in response to the control signal BG.

In the drive transistor DRT, the drain electrode is connected to the source electrode of the output switch BCT, and the source electrode is connected to a node N1. The drive transistor DRT outputs a drive current having a current amount corresponding to the video signal Vsig, to the light sources LED1 and LED2.

In the lighting control switch LCT1, the drain electrode is connected to the node N1, the source electrode is connected to one of electrodes (anode) of the light source LED1, and the gate electrode is connected to a lighting control signal line L2. Incidentally, the other electrode (cathode) of the light source LED1 is connected to the second power line SL2. The lighting control switch LCT1 is controlled to be turned on/off by a control signal LG supplied to the lighting control signal line L2. More specifically, the lighting control switch LCT1 is rendered conductive by an H-level control signal LG supplied to the lighting control signal line L2, and is rendered non-conductive by an L-level control signal LG. The lighting control switch LCT1 controls turning on (lighting) and off (extinguishing) of the light source LED1 in response to the control signal LG.

In the lighting control switch LCT2, the source electrode is connected to the node N1, the drain electrode is connected to one of electrodes (anode) of the light source LED2, and the gate electrode is connected to the lighting control signal line L2. Incidentally, the other electrode (cathode) of the light source LED2 is connected to the second power line SL2. The lighting control switch LCT2 is controlled to be turned on/off by the control signal LG supplied to the lighting control signal line L2. More specifically, the lighting control switch LCT2 is rendered conductive by the L-level control signal LG supplied to the lighting control signal line L2, and is rendered non-conductive by the H-level control signal LG. The lighting control switch LCT2 controls turning on (lighting) and off (extinguishing) of the light source LED2 in response to the control signal LG.

In the pixel selection switch SST, the source electrode is connected to a video signal line VL, the drain electrode is connected to the gate electrode of the drive transistor DRT, and the gate electrode is connected to a pixel selection control signal line L3. The pixel selection switch SST is controlled to be turned on and off by a control signal SG supplied from the pixel selection control signal line L3. The pixel selection switch SST controls connection and disconnection between the drive circuit DR and the video signal line VL in response to the control signal SG, and takes in the video signal Vsig from the video signal line VL to the drive circuit.

In the initializing switch IST, the source electrode is connected to the initialization line Sgi, the drain electrode is connected to the gate electrode of the drive transistor DRT, and the gate electrode is connected to an initialization control signal line L4. The initializing switch IST is controlled to be turned on and off by a control signal IG supplied from the initialization control signal line L4. The initializing switch IST controls connection and disconnection between the drive circuit DR and the initialization line Sgi in response to the control signal IG. An initial potential (initialization voltage) Vini can be taken in the drive circuit DR from the initialization line Sgi by connecting the drive circuit DR with the initialization line Sgi by the initializing switch IST.

In the reset switch RST, the source electrode is connected to a reset line Sgr, the drain electrode is connected to the gate electrode of the drive transistor DRT, and the gate electrode is connected to a reset control signal line L5. The reset line Sgr is connected to a reset power supply and fixed to a reset potential Vrst that is a constant potential. The reset switch RST is controlled to be turned on and off by a control signal RG supplied via the reset control signal line L5. The potential of the source electrode of the drive transistor DRT can be reset to the reset potential Vrst by switching the reset switch RST to be turned on.

The storage capacitor Cs is electrically connected between the gate electrode and the source electrode of the drive transistor DRT, as an equivalent circuit. The auxiliary capacitor Cad is connected between the source electrode of the drive transistor DRT and the first power line SL1 serving as a constant potential line, as an equivalent circuit.

The panel driver 5 shown in FIG. 1 controls the scanning line drive circuits YDR1 and YDR2 and the signal line drive circuit XDR. The panel driver 5 receives a digital video signal and a synchronization signal supplied from the outside, and generates a vertical scanning control signal controlling vertical scanning timing and a horizontal scanning control signal controlling horizontal scanning timing, based on the synchronization signal. The configuration in which two scanning line drive circuits YDR1 and YDR2 are provided has been illustrated, but the number of scanning line driving circuits may be one.

The panel driver 5 supplies each of the vertical scanning control signal and the horizontal scanning control signal to the scanning line drive circuits YDR1 and YDR2 and the signal line drive circuit XDR, and supplies the digital video signal and the initialization signal to the signal line drive circuit XDR in synchronization with the horizontal scanning timing and the vertical scanning timing.

The signal line drive circuit XDR converts video signals sequentially obtained in each horizontal scanning period under the control of the horizontal scanning control signal into an analog format and supplies video signals Vsig corresponding to gradation to a plurality of video signal lines VL. The panel driver 5 fixes the first power line SL1 to the high potential PVDD, fixes the second power line SL2 to the low potential PVSS, fixes the reset line Sgr to the reset potential Vrst, and fixes the initialization line Sgi to the initializing potential Vini. Incidentally, the potential of the first power line SL1, the potential of the second power line SL2, the potential of the reset line Sgr, and the potential of the initialization line Sgi may be set via the signal line drive circuit XDR.

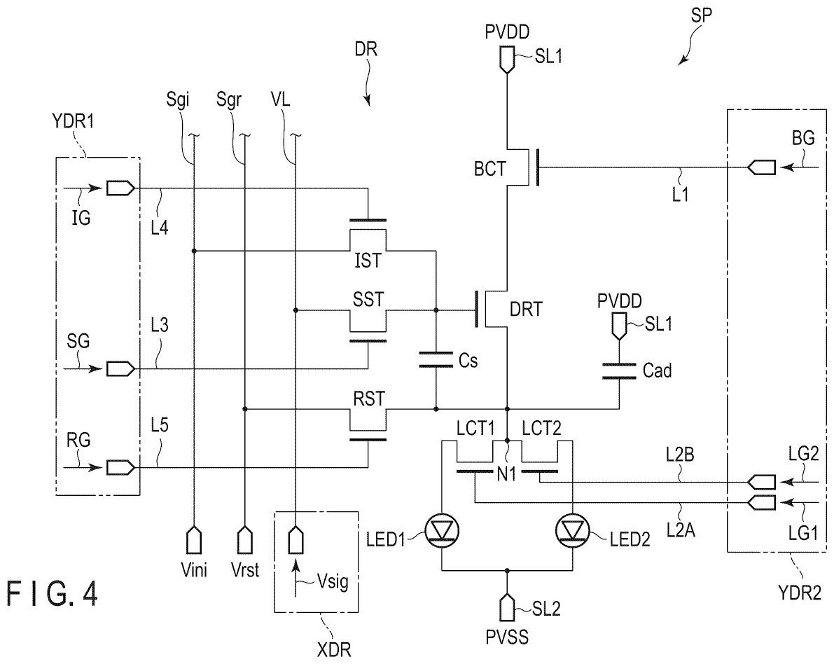

The circuit configuration of the sub-pixel SP illustrated in FIG. 3 is an example, and the circuit configuration of the sub-pixel SP may be the other configuration if the configuration includes at least the driving transistor DRT, the lighting control switches LCT1 and LCT2, and the light sources LED1 and LED2. For example, as shown in FIG. 4, both the lighting control switches LCT1 and LCT2 may be constituted by N-channel TFT, the lighting control signal line L2A may be connected to the gate electrode of the lighting control switch LCT1, and the lighting control signal line L2B may be connected to the gate electrode of the lighting control switch LCT2. In this configuration, the lighting control switch LCT1 is controlled to be turned on and off by the control signal LG1 supplied to the lighting control signal line L2A, and the lighting control switch LCT2 is controlled to be turned on and off by the control signal LG2 supplied to the lighting control signal line L2B. The control signal LG1 is supplied to the lighting control signal line L2A at timing different from that of the control signal LG2, and the control signal LG2 is supplied to the lighting control signal line L2B at timing different from that of the control signal LG1.

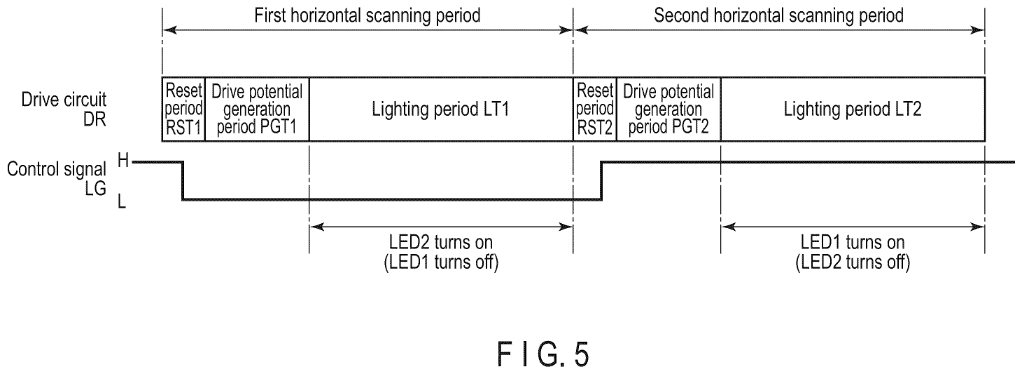

FIG. 5 is a view illustrating the lighting operations of the light sources LED1 and LED2. The drive circuit DR switches one of the light sources LED1 and LED2 from off to on and switches the other from on to off in each horizontal scanning period in which the scanning line drive circuit YDR2 supplies the control signals LG to the lighting control switches LCT1 and LCT2.

More specifically, as shown in FIG. 5, when the voltage of the control signal LG shifts from the H level to the L level during a reset period RST1 included in the first horizontal scanning period H1, the drive circuit DR generates a potential (drive potential) for driving the light sources LED1 and LED2, in a potential generation period PGT1 following the reset period RST1. Incidentally, the potential of the source electrode of the drive transistor DRT is reset to the reset potential Vrst in the reset period RST1.

In the lighting period LT1 following the potential generation period PGT1, the drive circuit DR outputs drive currents based on the generated drive potentials to the light sources LED1 and LED2. As described above, since the L-level control signals LG are supplied to the gate electrodes of the lighting control switches LCT1 and LCT2, the N-channel lighting control switch LCT1 is in a non-conductive state and the P-channel lighting control switch LCT2 is in a conductive state. In other words, in the lighting period LT1, the drive current output from the drive circuit DR flows only to the light source LED2, the light source LED2 is turned on, and the light source LED1 is turned off.

In contrast, when the voltage of the control signal LG shifts from the L level to the H level during the reset period RST2 included in the second horizontal scanning period H2 following the first horizontal scanning period H1, the drive circuit DR generates the drive potential during a potential generation period PGT2 following the reset period RST2. Incidentally, the potential of the source electrode of the drive transistor DRT is reset to the reset potential Vrst in the reset period RST2.

In the lighting period LT2 following the potential generation period PGT2, the drive circuit DR outputs drive currents based on the generated drive potentials to the light sources LED1 and LED2. As described above, since the H-level control signals LG are supplied to the gate electrodes of the lighting control switches LCT1 and LCT2, the N-channel lighting control switch LCT1 is in a conductive state and the P-channel lighting control switch LCT2 is in a non-conductive state. In other words, in the lighting period LT2, the drive current output from the drive circuit DR flows only to the light source LED1, the light source LED1 is turned on, and the light source LED2 is turned off.

By repeating the above-described lighting operation, it is possible to turn on only one of the two light sources LED1 and LED2 included in the sub-pixel SP and turn off the other. In other words, it is possible to alternately turn on the two light sources LED1 and LED2 included in the sub-pixel SP.

It has been described that the light sources LED1 and LED2 are alternately turned on in every horizontal scanning period, but the embodiment is not limited to this case and, for example, the light sources LED1 and LED2 may be turned on alternately every second (every sixty frames).

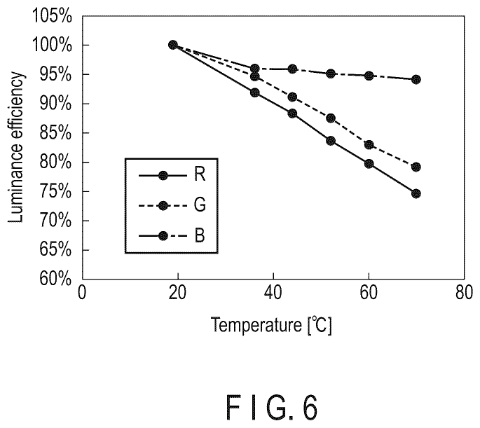

Advantages of the display device 1 according to the present embodiment will be described with reference to the temperature characteristics of the micro LED shown in FIG. 6.

FIG. 6 is a graph showing a relationship between the temperature and the luminance efficiency for each emission color of the micro LED. In FIG. 6, a solid line indicates temperature characteristics of a red micro-LED, a dashed line indicates temperature characteristics of a green micro-LED, and a one-dot chain line indicates temperature characteristics of a blue micro-LED. As shown in FIG. 6, the micro-LED has the characteristic that the luminance efficiency (which may be simply referred to as luminance) is lower as the temperature is higher, for any emission color. Since the micro-LED generates heat when turned on, the temperature of the micro-LED rises in proportion to the lighting time. In other words, the luminance efficiency of the micro-LED decreases in proportion to the lighting time. The decrease in the luminance efficiency of micro-LED may degrade the display quality of the display device using the micro-LED.

In contrast, the display device 1 according to the present embodiment comprises (a pixel PX including) sub-pixels SP including two light sources LED1 and LED2 and a drive circuit DR that alternately turn on the light sources LED1 and LED2. According to this, in the display device 1 according to the present embodiment, since one of the light sources LED1 and LED2 is turned on while the other can be turned off to dissipate heat, it is possible to suppress the temperature of the light sources LED1 and LED2 becoming too high and to suppress the luminance efficiency of the light sources LED1 and LED2 decreasing. Incidentally, the micro-LED, which are minute diode elements, are used for the light sources LED1 and LED2 and, even if two light sources LED1 and LED2 are provided for one sub-pixel SP, the size of the sub-pixel SP does not become larger than required as compared to the conventional size, which can sufficiently correspond to high definition and increase in size of the display device.

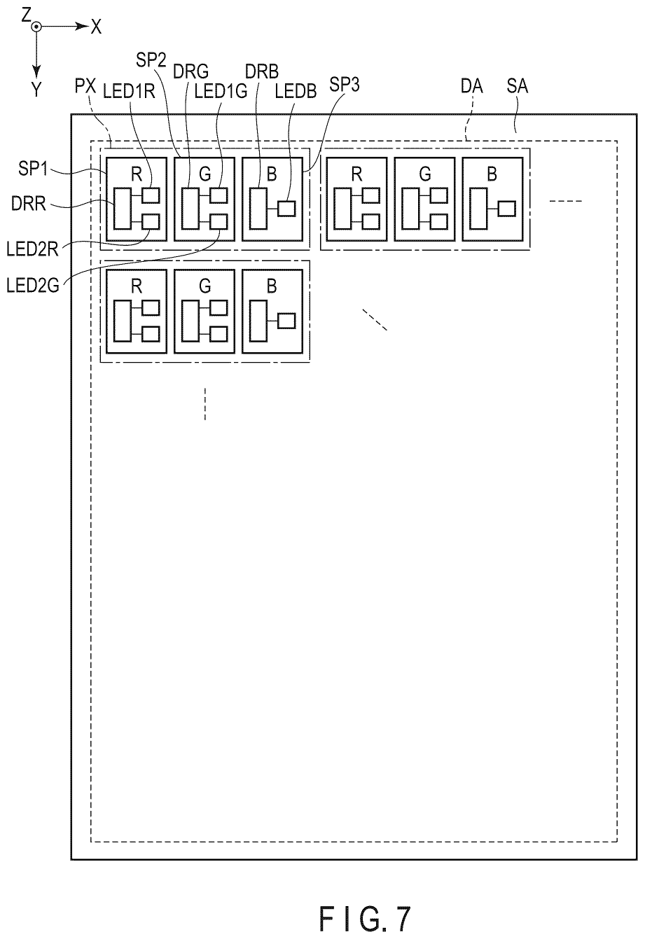

As shown in FIG. 6, the micro-LED has the characteristic that the luminance efficiency of the blue micro-LED is not so decreased even if the temperature rises, as compared to the red and green micro-LED. For this reason, as shown in FIG. 7, the configuration that the red sub-pixel SP1 and the green sub-pixel SP2 include two light sources LED1 (LED1R, LED1G) and LED2 (LED2R, LED2G) and a drive circuit DR (DRR, DEG) for alternately turning on these light sources LED1 and LED2, and that the blue sub-pixel SP3 includes one light source LEDB and a drive circuit DRB which controls turning on and off the light source LEDB, may be applied to the display device 1 according to the present embodiment. According to this configuration, it is possible to suppress the decrease in luminance efficiency of the light sources LED1 and LED2 included in the respective red sub-pixel SP1 and green sub-pixel SP2, which are easily affected by the temperature, while simplifying the configuration of the blue sub-pixel SP3, which is hardly affected by the temperature.

In addition, in the present embodiment, the rise in temperature of the light source LED is suppressed by alternately turning on the light sources LED1 and LED2 such that the heat generated when the light source LED is turned off is greater than the heat generated when the light source LED is turned on, but the present embodiment is not limited to this, and any configuration can be applied to the display device 1 according to the present embodiment as long as the rise in temperature of the light source LED can be suppressed.

In addition, if the optical characteristics of the light source LED1 and the light source LED2 are varied, the degradation in display quality may occur when the optical sources are alternately turned on. For this reason, the optical characteristics of the light source LED1 and the light source LED2 of the same color need to be made uniform as much as possible, and the optical characteristics of the light sources LED1 and LED2 desirably do not have significant variations.

According to at least one of the embodiments described above, the display device 1 capable of suppressing the degradation in display quality can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a display area where an image is displayed; and
a plurality of pixels arrayed in a matrix in the display area, wherein
each of the plurality of pixels comprises a first light source, a second light source, and a first drive circuit controlling operations of the first light source and the second light source, and
the first drive circuit turns off the second light source when turning on the first light source, and turns off the first light source when turning on the second light source.

2. The display device of claim 1, wherein
each of the plurality of pixels includes a first sub-pixel corresponding to a red color, a second sub-pixel corresponding to a green color, and a third sub-pixel corresponding to a blue color,
the first sub-pixel comprises the first light source and the second light source emitting red light, and the first drive circuit,
the second sub-pixel comprises the first light source and the second light source emitting green light, and the first drive circuit, and
the third sub-pixel comprises the first light source and the second light source emitting blue light, and the first drive circuit.

3. The display device of claim 1, wherein
each of the plurality of pixels includes a first sub-pixel corresponding to a red color, a second sub-pixel corresponding to a green color, and a third sub-pixel corresponding to a blue color,
the first sub-pixel comprises the first light source and the second light source emitting red light, and the first drive circuit,
the second sub-pixel comprises the first light source and the second light source emitting green light, and the first drive circuit, and
the third sub-pixel comprises a light source emitting blue light, and a second drive circuit controlling an operation of the light source.

4. The display device of claim 1, wherein
the first drive circuit includes a drive transistor outputting drive currents to the first light source and the second light source, a first switch, and a second switch,
the first switch is arranged between the drive transistor and the first light source, and
the second switch is arranged between the drive transistor and the second light source.

5. The display device of claim 4, wherein
the first drive circuit turns on the first switch and turns off the second switch when turning on the first light source, and
the first drive circuit turns off the first switch and turns on the second switch when turning on the second light source.

6. The display device of claim 5, wherein
the first switch is an N-channel transistor,
the second switch is a P-channel transistor, and
a control signal to turn on one of the first switch and the second switch and turn off the other is supplied to gate electrodes of the first switch and the second switch at same timing.

7. The display device of claim 5, wherein
the first switch and the second switch are N-channel transistors,
a first control signal to turn on the first switch is supplied to a gate electrode of the first switch, and
a second control signal to turn on the second switch is supplied to a gate electrode of the second switch at timing different from timing at which the first control signal is supplied to the first switch.

8. The display device of claim 6, wherein
each of a cathode of the first light source and a cathode of the second light source is connected to a common power line of a low potential,
an anode of the first light source is connected to a source electrode of the first switch, and
an anode of the second light source is connected to a drain electrode of the second switch.

9. The display device of claim 7, wherein
each of a cathode of the first light source and a cathode of the second light source is connected to a common power line of a low potential,
an anode of the first light source is connected to a source electrode of the first switch, and
an anode of the second light source is connected to a source electrode of the second switch.

10. The display device of claim 1, wherein the first light source and the second light source are micro-LED.
